(19) United States
(12) Patent Application Publication
(10) Pub. No.: US 2026/0283188 A1
(43) Pub. Date: Sep. 24, 2026

(54) FROZEN CONFECTION PRODUCT

(71) Applicant: Cargill, Incorporated, Wayzata, MN (US)

(72) Inventor: Susen GOTTWALD, Frankfurt am Main (DE)

(73) Assignee: Cargill, Incorporated, Wayzata, MN (US)

(21) Appl. No.: 19/473,325

(22) PCT Filed: Apr. 9, 2024
(86) PCT No.: PCT/US2024/023686

§ 371 Date: Oct. 7, 2025

(30) Foreign Application Priority Data
Apr. 11, 2023 (EP) 23167243.7

(51) Int. Cl. A23G 9/32; A23D 9/04

(52) U.S. Cl. CPC A23G 9/327; A23D 9/04

(57) ABSTRACT

The present invention relates to a frozen confection product comprising protein, sweetener, emulsifier, stabilizer and a fat and the fat is consisting of a fat composition having a fatty acid moiety content with a carbon chain length of C12 of not more than 20% based on total weight of the fatty acid moiety, and having a solid fat content at 10° C. of less than 25 wt. % and at 20° C. of less than 6 wt %; and consisting of a liquid oil and an interesterified lauric fat and having a weight ratio of from 55 wt % liquid oil and 45 wt % interesterified lauric fat, to a weight ratio of 60 wt % liquid oil and 40 wt % interesterified lauric fat. It relates to a process for preparing the frozen confection product. It further relates to the use of the fat composition to reduce the saturated fat content of a frozen confection product.

### CROSS-REFERENCE TO RELATED APPLICATIONS

This application claims the benefit of European Patent Application No. 23167243.7, filed Apr. 11, 2023, which is incorporated by reference herein in its entirety.

### FIELD OF THE INVENTION

The present invention relates to a frozen confection product reduced in saturated fat content, and a process for preparing the frozen confection product.

### BACKGROUND OF THE INVENTION

Frozen dairy dessert products such as ice cream, ice milk, milk shakes, sherbet, yogurt, sorbet and the aerated versions thereof, are popular due to their convenience, wide spread availability, nutritive value and appealing forms, flavors, and colors.

A weight conscious society has further popularized non-fat and low-fat preparations, while consumer expectations such as flavor, appearance, and in particular the physical properties of aerated frozen dessert products remain high priority.

The combination of rigid consumer acceptance criteria, regulatory standards and the complex nature of the interactions which produce an acceptable frozen dessert product, make it difficult to formulate an aerated frozen dessert having improved characteristics, particularly when formulating a reduced or non-fat product containing only natural components and ingredients.

The foregoing factors are also true for frozen dairy dessert products such as ice cream bars, dessert bars, yogurt bars, ice milk bars, fudge pops and the like.

There is thus still a need in the industry for frozen confection product reduced saturated fat content while maintaining or improving the textural and/or sensorial properties. The present invention provides such a product.

### SUMMARY OF THE INVENTION

The present invention relates to a frozen confection product comprising protein, sweetener, emulsifier, stabilizer and fat and the fat is consisting of a fat composition wherein the fat composition has a fatty acid moiety content with a carbon chain length of C12 of not more than 20% based on total weight of the fatty acid moiety; and
the fat composition has a solid fat content at 10° C. of less than 25 wt. % and at 20° C. of less than 6 wt %; and
the fat composition is consisting of a liquid oil and an interesterified lauric fat and having a weight ratio of from 55 wt % liquid oil and 45 wt % interesterified lauric fat, to a weight ratio of 60 wt % liquid oil and 40 wt % interesterified lauric fat.

It relates to a frozen confection product prepared by adding a fat composition to frozen confection product ingredients and wherein the fat composition is consisting of a liquid oil and an interesterified lauric fat and having a weight ratio of from 55 wt % liquid oil and 45 wt % interesterified lauric fat, to a weight ratio of 60 wt % liquid oil and 40 wt % interesterified lauric fat.

It describes a process for preparing the frozen confection product of the present invention and the process is comprising:
Blending a fat composition with frozen confection product ingredients other than fat,
Freezing the blend, and
   Wherein the fat composition is consisting of a liquid oil and an interesterified lauric fat, and the fat composition is having a weight ratio of from 55 wt % liquid oil and 45 wt % interesterified lauric fat, to a weight ratio of 60 wt % liquid oil and 40 wt % interesterified lauric fat.

It further relates to the use of a fat composition consisting of a liquid oil and an interesterified lauric fat to reduce the saturated fat content of a frozen confection product, and wherein the fat composition is having a weight ratio of from 55 wt % liquid oil and 45 wt % interesterified lauric fat, to a weight ratio of 60 wt % liquid oil and 40 wt % interesterified lauric fat.

Finally, it describes a fat composition consisting of a liquid oil and an interesterified lauric fat wherein the interesterified fat is derived from coconut oil, coconut stearin, babassu oil, palm kernel oil or palm kernel stearin, and the liquid oil is selected from the group consisting of rapeseed oil, high oleic rapeseed oil, sunflower oil, high oleic sunflower oil or a mixture of two or more thereof, and wherein
the fat composition is having a weight ratio of from 55 wt % liquid oil and 45 wt % interesterified lauric fat, to a weight ratio of 60 wt % liquid oil and 40 wt % interesterified lauric fat; and
the fat composition has a solid fat content at 10° C. of less than 25 wt. % and at 20° C. of less than 6 wt %.

### DETAILED DESCRIPTION

The present invention relates to a frozen confection product comprising protein, sweetener, emulsifier, stabilizer and fat and the fat is consisting of a fat composition wherein the fat composition has a fatty acid moiety content with a carbon chain length of C12 of not more than 20% based on total weight of the fatty acid moiety; and
the fat composition has a solid fat content at 10° C. of less than 25 wt. % and at 20° C. of less than 6 wt %; and
the fat composition is consisting of a liquid oil and an interesterified lauric fat and having a weight ratio of from 55 wt % liquid oil and 45 wt % interesterified lauric fat, to a weight ratio of 60 wt % liquid oil and 40 wt % interesterified lauric fat.

“Frozen,” as used herein, denotes that the product is solidified under freezing conditions to a hardpack or pumpable consistency, or a soft, semi-fluid, or spoonable consistency.

The protein used in the present invention is obtained from a source containing milk protein. Milk protein may be derived from any suitable milk source, as for example, skim milk, condensed skim milk, ultrafiltered skim milk concentrate or retentate, milk powder, lactose-reduced nonfat milk, milk protein isolate, and the like.

Without being bound by any theory, it may be that a source of milk protein is acting as a source of high molecular weight compounds to provide body and texture to the frozen confection product and decrease sensitivity to temperature fluctuations and increase stability to heat shock of the frozen confection product. Primarily, milk proteins include casein and whey protein. It is preferred that the milk protein component has a casein to whey protein ratio according to that found naturally in skim milk, or about 4:1.

The sweetener used in the present invention can be any sweetener that is commonly used in frozen confection product. It may be a natural or artificial sweetening agent.

Stabilizer and emulsifier have been used in an attempt to improve the heat shock stability, appearance and shelf life of the frozen confection product. Examples of stabilizers which have traditionally been used in frozen confection product such as ice cream include gum acacia, guar gum, locust bean gum, carob bean gum, carrageenan, and the like. Often microcrystalline cellulose and carboxymethylcellulose are used in combination with the previously mentioned gums to maximize their functional effectiveness, to reduce the degree of ice crystal growth by influencing viscosity and other rheological properties, thus limiting the mobility of water in the unfrozen aqueous portion.

Emulsifiers are the ones that are commonly used in frozen confection product and help providing stability by facilitating the formation of an interface between the aqueous phase and the fat phase. Examples of known emulsifiers include mono- and di-glycerides of saturated or unsaturated fatty acids (for example monoglyceryl palmitate), polyoxyethylene derivatives of hexahydric alcohols (usually sorbitol), glycols, glycol esters, polyglycerol esters, sorbitan esters, stearoyl lactylate, lactic acid esters, citric acid esters, acetylated monoglyceride, diacetyl tartaric acid esters, polyoxyethylene sorbitan esters, lecithin and egg yolk and mixtures thereof. Preferably the emulsifier is a mono-/di-glyceride of saturated fatty acids with a monoglyceride content of at least 40 percent.

Preferably the frozen confection product comprises at most 1 wt % (by weight of the product) emulsifier, at most 0.75 wt %, at most 0.5 wt %, at most 0.4 wt %, at most 0.3 wt %, at most 0.2 wt %, at most 0.1 wt %.

The fat composition having a fatty acid moiety content of C12 of not more than 20 wt. % refers to the content of C12 aliphatic moiety of the fatty acids present in the fat composition. The content is not more than 20 wt. %. It indicates that not more than 20 wt % of the fat composition contains C12 fatty acid chains.

The fat composition has a Solid Fat Content (SFC) at 10° C. of less than 25 wt. % and less than 6 wt % at 20° C. of whereby Solid Fat Content is the percentage of solids in fat at specified temperatures and is measured according to method well known in the art.

The fat composition in the frozen confection product according to the present invention is consisting of a liquid oil and an interesterified lauric fat, and the fat composition is having a weight ratio of from 55 wt % liquid oil and 45 wt % interesterified lauric fat, to a weight ratio of 60 wt % liquid oil and 40 wt % interesterified lauric fat.

The term “liquid oil” is defined as triglycerides with a melting point of less than 20° C. (at atmospheric pressure). The liquid oil can be one liquid oil or a blend of more than one liquid oils. In case of a blend of liquid oils, it is understood that the blend of the more than one liquid oil has a melting point of less than 20° C. (at atmospheric pressure).

The “liquid oil” is a vegetable oil.

Examples of vegetable liquid oils are amongst others double fractionated palm olein, cottonseed oil, corn oil, groundnut oil, linseed oil, olive oil, rapeseed oil, rice bran oil, sesame oil, safflower oil, soybean oil, sunflower oil, oil from any variety of oilseeds with increased level of unsaturated fatty acids compared to the original seed variety, such as mid or high oleic sunflower oil. These varieties with increased levels of unsaturated fatty acids can be obtained by natural selection or by genetic modification (GMO). Preferably, the vegetable oil is selected from the group consisting of canola oil, cottonseed oil, corn oil, flaxseed oil, grapeseed oil, groundnut oil, linseed oil, olive oil, peanut oil, rapeseed oil, rice bran oil, sesame oil, safflower oil, soybean oil, sunflower oil, their corresponding high oleic varieties, and mixtures of two or more thereof. More preferably, the vegetable oil is selected from the group consisting of corn oil, rapeseed oil, soybean oil, sunflower oil, their corresponding high oleic varieties, and mixture of two or more thereof. The high oleic varieties are containing at least 40%, at least 50%, at least 60%, at least 70% and preferably at least 80% oleic acid in respect of the fatty acid profile.

In one aspect of the invention, the liquid oil is selected from the group consisting of rapeseed oil, high oleic rapeseed oil, sunflower oil, high oleic sunflower oil, canola oil, high oleic canola oil, high oleic soybean oil, soybean oil, flaxseed oil, grapeseed oil, olive oil, peanut oil, corn oil, groundnut oil, cottonseed oil and a combination of two or more thereof.

The interesterified fat is a randomly interesterified fat, which is a triglyceride composition wherein the fatty acids that are bound as acyl group in glycerides are randomly distributed over the glycerol backbone of the triglycerides. It can be obtained by means of a process of chemical or enzymatic interesterification.

A chemical interesterification is performed by using a basic catalyst, such as, but not limited to, sodium methoxide or sodium ethoxide.

An enzymatic interesterification is obtained by means of a lipase enzyme. The lipase will generally be non-selective for the positions on the glyceride backbone in order to achieve the optimum random interesterification. Alternatively, selective lipases may be used, provided that the reaction conditions are such that no significant selectivity is observed, for example by running the reaction for extended periods of time. Suitable lipases include the lipases from Thermomyces lanuginosa, Rhizomucor miehei, Rhizopus delemar and Candida rugosa. Preferably, the lipase is suitable for use with food products.

The interesterified fat may be characterized by the position of the saturated(S) and/or unsaturated (U) fatty acids bound onto the glycerol backbone of the triglycerides of the fat. Typically, the abbreviation S is used to denote a saturated fatty acid residue having 8 to 24 carbon atoms. The abbreviation U denotes an unsaturated fatty acid residue having 16 to 24 carbon atoms. Thus, a triglyceride having saturated fatty acids at the 1- and 3-positions and an unsaturated fatty acid at the 2-position of the glycerol backbone is denoted SUS. Likewise, a triglyceride having 2 saturated fatty acids at the 1- and at the 2-position of the glycerol backbone and an unsaturated fatty acid at the remaining 3-position is denoted SSU.

The ratio of SUS over SSU (SUS/SSU) of a fully randomized triglyceride composition is 0.5, whereas the SUS/SSU ratio of a non-randomized triglyceride is significantly higher than 1.

The triglyceride composition of the interesterified fat is characterized by a ratio of SUS over SSU (SUS/SSU) in a range of from 0.5 to 1.0, from 0.6 to 0.9, or from 0.7 to 0.8.

In one aspect of the invention, the interesterified fat is obtained by means of a chemical interesterification.

In the present invention, the interesterified fat is sourced from a lauric oil selected from coconut oil, coconut stearin, babassu oil, palm kernel oil or palm kernel stearin, cohune oil, tacum oil and cuphea oil, hydrogenated coconut oil, palm kernel oil, fully or partially hydrogenated palm kernel oil, palm kernel stearin, hydrogenated palm kernel stearin, palm kernel olein, fully or partially hydrogenated palm kernel olein, or a mixture of two or more thereof. In one aspect the interesterified fat is interesterified coconut oil.

In an aspect of the invention, the frozen confection product is comprising the fat composition in an amount of 2 to 10 wt % fat composition based on the weight of the frozen confection product.

In an aspect of the invention, the frozen confection product is comprising
2.0 to 10 wt % fat composition
0.5 to 4 wt % protein
10 to 30% sweetener
0.1 to 1 wt % emulsifier, and
0.1 to 1 wt % stabilizer, based on the weight of the frozen confection product, and wherein the fat composition is consisting of a liquid oil and an interesterified lauric fat. The balance (to 100%) is water.

In an aspect, the frozen confection product of the present invention is prepared by adding a fat composition to frozen confection product ingredients (other than fat) and wherein the fat composition is consisting of a liquid oil and an interesterified lauric fat.

The frozen confection product ingredients are the ingredients mentioned before, such as protein, sweetener, emulsifier, stabilizer, and water.

In one aspect of the invention, the fat composition that is added to the frozen confection product ingredients is consisting of a liquid oil and an interesterified lauric fat and is having a weight ratio of from 55 wt % liquid oil and 45 wt % interesterified lauric fat, to a weight ratio of 60 wt % liquid oil and 40 wt %. In fact, the fat composition may consist of 55 wt % liquid oil and 45 wt % interesterified lauric fat, up to 60 wt % of liquid oil and 40 wt % of interesterified lauric fat.

In an aspect of the invention, the frozen confection product is prepared by adding to the frozen confection product ingredients an interesterified fat and a liquid oil.

The liquid oil can be added in an amount of 1.1 to 6 wt % based upon weight of the frozen confection product. The interesterified fat may be added in an amount of 0.8 to 4.5 wt % based upon weight of the frozen confection product.

In another aspect of the invention, the liquid oil may be added in an amount of 3.3 to 3.6 wt % based upon weight of the frozen confection product and the interesterified fat is added in an amount of 2.4 to 2.7 wt % based on weight of the frozen confection product.

The frozen confection product of the present invention is selected from ice cream, frozen custard, ice milk, frozen yogurt, sherbet, water ices, mellorine, frozen dairy desserts for special dietary purposes, dairy dessert bars, frozen mousse desserts.

In an aspect of the invention, the frozen confection product of the present invention is selected from ice cream, frozen custard, ice milk, frozen yogurt, sherbet, mellorine, dairy dessert bars, frozen mousse desserts.

In one aspect of the invention, the frozen confection product is ice cream or mellorine.

Ice cream has the highest fat content, ranging from 5 wt. % percent, up to 16 wt. % for so-called premium ice cream.

Frozen custard, or French ice cream, is basically the same formula as ice cream but contains added eggs or egg solids (usually 1.4 percent by weight).

Ice milk may be more commonly called “light” or “reduced-fat” ice cream. It contains between 2 and 7 percent fat and at least 11 percent total milk solids.

Frozen yogurt is a cultured frozen product containing the same ingredients as ice cream. It must contain at least 3.25 percent milk fat and 8.25 percent milk solids.

Low-fat frozen yogurt contains between 0.5 and 2 percent milk fat. Frozen yogurts should always contain live cultures of bacteria.

Sherbets contain relatively small quantities of milk products. Most standards require between 1 and 2 percent milk fat and between 2 and 5 percent total milk solids. Sherbet contains considerably more sugar and less air than ice cream (the target overrun is 30 to 40 percent), and therefore it is heavier and often contains more calories per serving.

Water ices are similar to sherbet, but they contain no milk solids and have a target overrun of 20 to 30 percent.

Imitation ice cream, known as mellorine, is made in some parts of the United States and other countries. It is made with vegetable oils instead of butterfat but uses dairy ingredients for the milk protein part.

Frozen dessert bar may be an ice cream or mellorine filling coated with chocolate and/or wafer.

Frozen mousse is a frozen dessert of a frothy texture, made of sweetened and flavored whipped cream, sometimes with the addition of egg yolks and gelatine. Mousse differs from ice cream in being beaten before—not during—the freezing process.

In one aspect of the invention, the frozen confection product is ice cream or mellorine wherein the fat composition is consisting of high oleic sunflower oil and interesterified coconut oil.

A typical way to access the quality of frozen confection product is done by measuring its overrun. Overrun refers to the degree of expansion resulting from the amount of air incorporated into the product during the freezing process. An overrun of around 100% indicates that air makes up 50% of its volume.

Overrun is defined by the formula:

overrun (%)=(weight of mix−weight of aerated product)/(weight of aerated product)×100,

where the weights refer to a fixed volume of mix or product. Overrun is measured at atmospheric pressure.

The frozen confection product may be aerated or unaerated. By unaerated is meant an overrun of less than 20%, preferably less than 10%. An unaerated frozen confection is not subjected to deliberate steps such as whipping to increase the gas content. Preferably the frozen confection product is aerated. Aerated frozen confection products have an overrun of more than 20%, preferably more than 50%, or more than 75%. Preferably the frozen confection product has an overrun of less than 200%, less than 150%, or less than 120%.

The target overrun for ice cream, ice milk, and frozen yogurt may be 65 to 100 percent. Premium ice creams may be as low as 20 percent overrun, while soft ice creams are in the 30 to 50 percent range.

The present invention further relates to a process for preparing the frozen confection product of the invention and the process is comprising:
Blending a fat composition with frozen confection product ingredients other than fat,
Freezing the blend, and
Wherein the fat composition is consisting of a liquid oil and an interesterified lauric fat and the fat composition is having a weight ratio of from 55 wt % liquid oil and 45 wt % interesterified lauric fat, to a weight ratio of 60 wt % liquid oil and 40 wt % interesterified lauric fat.

Usually, the first step in ice cream making is formulating a suitable mix. The mix is composed of the frozen confection product ingredients such as protein, sweetener, emulsifier, stabilizer and fat composition. As mentioned before, the stabilizers and emulsifiers are added in small amounts to help prevent formation of ice crystals, particularly during temperature fluctuations in storage.

The ice cream mix is heated to a temperature of at least 79° C. The heated mix is typically homogenized in order to assure a smoother body and texture. Homogenizing also prevents churning (i.e., separating out of fat granules) of the mix in the freezer and increases the viscosity.

After homogenization, the hot mix is quickly cooled to below 5° C. The mix must age at this temperature for at least four hours to allow the fat to solidify and fat globules to clump.

This aging process results in quicker freezing and a smoother product. The next step, freezing the mix, to freeze the product partially and, at the same time, incorporate air.

Semi-frozen ice cream leaves the freezer at a temperature between −9 and −5° C. (16 and 23° F.). It is placed in a suitable container and conveyed to a blast freezer, where temperatures are in the range of −29 to −34° C. While in this room, the ice cream continues to freeze without agitation. Rapid freezing at this stage prevents the formation of large ice crystals and favours a smooth body and texture. The length of time in the hardening room depends on the size of the package, but usually 4 to 12 hours are required to bring the internal ice cream temperature to −18° C. or below. In larger manufacturing plants, final freezing takes place in a hardening tunnel, where packages are automatically conveyed on a continuous belt to the final storage area.

Furthermore, the present invention relates to the frozen confection product obtainable by the process of the current invention.

The present invention further relates to a use of fat composition consisting of a liquid oil and an interesterified lauric fat to reduce the saturated fat content of a frozen confection product, and wherein the fat composition is having a weight ratio of from 55 wt % liquid oil and 45 wt % interesterified lauric fat, to a weight ratio of 60 wt % liquid oil and 40 wt % interesterified lauric fat.

In one aspect, the fat composition is present in the frozen confection product in an amount of 2 to 10 wt % of the fat composition based on the weight of the frozen confection product.

In an aspect of the invention, the use allows for a reduction of the saturated fat content with at least 50%.

Finally, the present invention relates to a fat composition consisting of a liquid oil and an interesterified lauric fat wherein the interesterified fat is derived from coconut oil, coconut stearin, babassu oil, palm kernel oil or palm kernel stearin, and, the liquid oil is selected from the group consisting of rapeseed oil, high oleic rapeseed oil, sunflower oil, high oleic sunflower oil or a mixture of two or more thereof; and wherein
the fat composition is having a weight ratio of from 55 wt % liquid oil and 45 wt % interesterified lauric fat, to a weight ratio of 60 wt % liquid oil and 40 wt % interesterified lauric fat; and
the fat composition has a solid fat content at 10° C. of less than 25 wt. % and at 20° C. of less than 6 wt %.

In an aspect of the invention, the liquid oil of the fat composition is derived from sunflower oil and the interesterified fat is interesterified coconut oil.

In an aspect of the invention, the liquid oil of the fat composition is high oleic sunflower oil and the interesterified fat is interesterified coconut oil, having a weight ratio of from 55 wt % high oleic sunflower oil and 45 wt % interesterified coconut oil, to a weight ratio of 60 wt % high oleic sunflower oil and 40 wt % interesterified coconut oil.

In an aspect of the invention, the fat composition has a content of the C12 fatty acid moiety of not more than 20 wt. %.

It has been found that the frozen confection product according to the present invention, allow to have a higher content of liquid oil present in the fat composition while having the same or improved textural and/or sensorial properties compared to existing frozen confection products that are based on coconut oil and/or a blend of coconut oil with liquid oil.

Surprisingly, it was found that the same melting curve of the frozen confection product is obtained with the claimed fat composition that has a lower SAFA content and lower solid fat content at 10° C. and 15° C. compared to fat compositions used in existing frozen confection products (that are based on coconut oil and/or a blend of coconut oil with liquid oil).

### CLAUSES

1. A frozen confection comprising protein, sweetener, emulsifier, stabilizer and fat and the fat is consisting of a fat composition wherein the fat composition wherein the fat composition has a fatty acid moiety content with a carbon chain length of C12 of not more than 20% based on total weight of the fatty acid moiety.
2. A frozen confection product wherein the fat composition has a solid fat content at 10° C. of less than 25 wt. % and at 20° C. of less than 6 wt %.
3. A frozen confection product comprising protein, sweetener, emulsifier, stabilizer and a fat composition wherein the fat composition is consisting of a liquid oil and an interesterified lauric fat.
4. The frozen confection product according to any one of the preceding clauses wherein the fat composition is present in an amount of 2 to 10 wt % fat composition based on the weight of the frozen confection product.
5. The frozen confection product according to any one of the preceding clauses wherein the frozen confection product is comprising
   2.0 to 10 wt % fat composition
   0.5 to 4 wt % protein
   10 to 30% sweetener
   0.1 to 1 wt % emulsifier, and
   0.1 to 1 wt % stabilizer, based on the weight of the frozen confection product, and
   wherein the fat composition is consisting of a liquid oil and an interesterified lauric fat.
6. The frozen confection product according to any one of the preceding clauses wherein the interesterified fat is characterized by a ratio of SUS over SSU (SUS/SSU) in a range of from 0.5 to 1.0, from 0.6 to 0.9, or from 0.7 to 0.8.
7. The fat confection according to any one of the preceding clauses wherein the fat composition is having a weight ratio of 55 wt % liquid oil and 45 wt % interesterified lauric fat, to a weight ratio of 60 wt % liquid oil and 40 wt % interesterified lauric fat.
8. The frozen confection product according to any one of the preceding clauses wherein the fat composition is having a weight ratio of 57 wt % liquid oil and 43 wt % interesterified lauric fat, to a weight ratio of 58 wt % liquid oil and 42 wt % interesterified lauric fat.
9. The frozen confection product according to any one of the preceding clauses wherein the lauric fat of the interesterified fat is selected from coconut oil, coconut stearin, babassu oil, palm kernel oil or palm kernel stearin, cohune oil, tacum oil and cuphea oil, hydrogenated coconut oil, palm kernel oil, fully or partially hydrogenated palm kernel oil, palm kernel stearin, hydrogenated palm kernel stearin, palm kernel olein, fully or partially hydrogenated palm kernel olein, or a mixture of two or more thereof.
10. The frozen confection product according to any one of the preceding clauses wherein the interesterified fat is interesterified coconut oil.
11. The frozen confection product according to any one of the preceding clauses wherein the liquid oil is selected from the group consisting of: canola oil, cottonseed oil, corn oil, flaxseed oil, grapeseed oil, groundnut oil, linseed oil, olive oil, peanut oil, rapeseed oil, rice bran oil, sesame oil, safflower oil, soybean oil, sunflower oil, their corresponding high oleic varieties, and mixtures of two or more thereof. More preferably, the vegetable oil is selected from the group consisting of corn oil, rapeseed oil, soybean oil, sunflower oil, their corresponding high oleic varieties, and mixture of two or more thereof.
12. The frozen confection product according to any one of the preceding clauses wherein the liquid oil is selected from the group consisting of rapeseed oil, high oleic rapeseed oil, sunflower oil, high oleic sunflower oil, canola oil, high oleic canola oil, high oleic soybean oil, soybean oil, flaxseed oil, grapeseed oil, olive oil, peanut oil, corn oil, groundnut oil, cottonseed oil and a combination of two or more thereof.
13. The frozen confection product according to any one of the preceding clauses wherein the liquid oil is derived from sunflower oil.
14. The frozen confection product according to any one of the preceding clauses wherein the liquid oil is high oleic sunflower oil.
15. The frozen confection product according to any one of the preceding clauses wherein the fat composition is consisting of high oleic sunflower oil and interesterified coconut oil.
16. The frozen confection product according to any one of the preceding clauses wherein the fat composition is consisting of 60 wt. % high oleic sunflower oil and 40 wt % of interesterified coconut oil.
17. The frozen confection product according to any one of the preceding clauses wherein the frozen confection product is selected from ice cream, frozen custard, ice milk, frozen yogurt, sherbet, water ices, mellorine, frozen dairy desserts for special dietary purposes, dairy dessert bars, frozen mousse desserts.
18. The frozen confection product according to any one of the preceding clauses wherein the frozen confection product is ice cream or mellorine.
19. A frozen confection product prepared by adding a fat composition to frozen confection product ingredients other than fat and wherein the fat composition is consisting of a liquid oil and an interesterified lauric fat.
20. The frozen confection product according to clause 19 wherein the fat composition is consisting of weight ratio of 55 wt % liquid oil and 45 wt % interesterified lauric fat, to a weight ratio of 60 wt % liquid oil and 40 wt % interesterified lauric fat.
21. The frozen confection product according to any one of clauses 19 to 20 wherein the fat composition is consisting of weight ratio of 57 wt % liquid oil and 43 wt % interesterified lauric fat, to a weight ratio of 58 wt % liquid oil and 42 wt % interesterified lauric fat.
22. The frozen confection product according to any one of clauses 19 to 21 wherein the lauric fat of the interesterified fat is selected from coconut oil, coconut stearin, babassu oil, palm kernel oil or palm kernel stearin, cohune oil, tacum oil and cuphea oil, hydrogenated coconut oil, palm kernel oil, fully or partially hydrogenated palm kernel oil, palm kernel stearin, hydrogenated palm kernel stearin, palm kernel olein, fully or partially hydrogenated palm kernel olein, or a mixture of two or more thereof.
23. The frozen confection product according to any one of the clauses 19 to 22 wherein the interesterified fat is interesterified coconut oil.
24. The frozen confection product according to any one of the clauses 19 to 23 wherein the liquid oil is selected from the group consisting of: canola oil, cottonseed oil, corn oil, flaxseed oil, grapeseed oil, groundnut oil, linseed oil, olive oil, peanut oil, rapeseed oil, rice bran oil, sesame oil, safflower oil, soybean oil, sunflower oil, their corresponding high oleic varieties, and mixtures of two or more thereof. More preferably, the vegetable oil is selected from the group consisting of corn oil, rapeseed oil, soybean oil, sunflower oil, their corresponding high oleic varieties, and mixture of two or more thereof.
25. The frozen confection product according to any one of the clauses 19 to 24 wherein the liquid oil is selected from the group consisting of rapeseed oil, high oleic rapeseed oil, sunflower oil, high oleic sunflower oil, canola oil, high oleic canola oil, high oleic soybean oil, soybean oil, flaxseed oil, grapeseed oil, olive oil, peanut oil, corn oil, groundnut oil, cottonseed oil and a combination of two or more thereof.
26. The frozen confection product according to any one of clauses 19 to 25 wherein the liquid oil is derived from sunflower oil.
27. The frozen confection product according to any one of clauses 19 to 26 wherein the liquid oil is high oleic sunflower oil.
28. The frozen confection product according to any one of clauses 19 to 27 wherein the fat composition is consisting of high oleic sunflower oil and interesterified coconut oil.
29. The frozen confection product according to any one of clauses 19 to 28 wherein the fat composition is consisting of 60 wt. % high oleic sunflower oil and 40 wt % of interesterified coconut oil.
30. The frozen confection product according to any one of clauses 19 to 29 wherein the fat composition has a content of C12 fatty acid moiety of not more than 20 wt. %.
31. The frozen confection product according to any one of clauses 19 to 30 wherein the fat composition has a solid fat content at 10° C. of less than 25 wt. % and at 20° C. of less than 6 wt %.
32. The frozen confection product according to any one of clauses 19 to 31 wherein the frozen confection product is selected from ice cream, frozen custard, ice milk, frozen yogurt, sherbet, water ices, mellorine, frozen dairy desserts for special dietary purposes, dairy dessert bars, frozen mousse desserts.
33. The frozen confection product according to any one of clauses 19 to 32 wherein the frozen confection product is ice cream or mellorine.
34. The frozen confection product according to any one of preceding clauses wherein fat composition of the frozen confection product has a ratio of fatty acid moieties C12/C16 of 2 to 3.8.
35. The frozen confection product according to any one of preceding clauses wherein fat composition of the frozen confection product is containing less than 50 wt. % of saturated fatty acids.
36. A process for preparing the frozen confection product according to any one of clauses 1 to 35 and the process is comprising:
   Blending a fat composition with frozen confection product ingredients other than fat
   Freezing the blend
   Wherein the fat composition is consisting of a liquid oil and an interesterified lauric fat.
37. The process according to clause 36 wherein the fat composition is present in an amount of 2 to 10 wt % fat composition based on the weight of the frozen confection product.
38. The process according to clause 36 or 37 wherein the frozen confection product is comprising
   2.0 to 10 wt % fat composition
   0.5 to 4 wt % protein
   10 to 30% sweetener
   0.1 to 1 wt % emulsifier, and
   0.1 to 1 wt % stabilizer, based on the weight of the frozen confection product, and
   wherein the fat composition is consisting of a liquid oil and an interesterified lauric fat.
39. The process according to any one of clauses 36 to 38 wherein the fat composition is consisting of weight ratio of 55 wt % liquid oil and 45 wt % interesterified lauric fat, to a weight ratio of 60 wt % liquid oil and 40 wt % interesterified lauric fat.
40. The process according to any one of clauses 36 to 39 wherein the fat composition is consisting of weight ratio of 57 wt % liquid oil and 43 wt % interesterified lauric fat, to a weight ratio of 58 wt % liquid oil and 42 wt % interesterified lauric fat.
41. The process according to any one of clauses 36 to 40 wherein the lauric fat of the interesterified fat is selected from coconut oil, coconut stearin, babassu oil, palm kernel oil or palm kernel stearin, cohune oil, tacum oil and cuphea oil, hydrogenated coconut oil, palm kernel oil, fully or partially hydrogenated palm kernel oil, palm kernel stearin, hydrogenated palm kernel stearin, palm kernel olein, fully or partially hydrogenated palm kernel olein, or a mixture of two or more thereof.
42. The process according to any one of clauses 36 to 41 wherein the interesterified fat is interesterified coconut oil.
43. The process according to any one of clauses 36 to 42 wherein the liquid oil is selected from the group consisting of: canola oil, cottonseed oil, corn oil, flaxseed oil, grapeseed oil, groundnut oil, linseed oil, olive oil, peanut oil, rapeseed oil, rice bran oil, sesame oil, safflower oil, soybean oil, sunflower oil, their corresponding high oleic varieties, and mixtures of two or more thereof. More preferably, the vegetable oil is selected from the group consisting of corn oil, rapeseed oil, soybean oil, sunflower oil, their corresponding high oleic varieties, and mixture of two or more thereof.
44. The process according to any one of the clauses 36 to 43 wherein the liquid oil is selected from the group consisting of rapeseed oil, high oleic rapeseed oil, sunflower oil, high oleic sunflower oil, canola oil, high oleic canola oil, high oleic soybean oil, soybean oil, flaxseed oil, grapeseed oil, olive oil, peanut oil, corn oil, groundnut oil, cottonseed oil and a combination of two or more thereof.
45. The process according to any one of clauses 36 to 44 wherein the liquid oil is derived from sunflower oil.
46. The process according to any one of clauses 36 to 45 wherein the liquid oil is high oleic sunflower oil.
47. The process according to any one of clauses 36 to 46 wherein the fat composition is consisting of high oleic sunflower oil and interesterified coconut oil.
48. The process according to any one of clauses 36 to 47 wherein the fat composition is consisting of 60 wt. % high oleic sunflower oil and 40 wt % of interesterified coconut oil.
49. The process according to any one of clauses 36 to 48 wherein the fat composition has a fatty acid moiety content of C12 of not more than 20 wt. %.
50. The process according to any one of clauses 36 to 49 wherein the fat composition has a solid fat content at 10° C. of less than 25 wt. % and at 20° C. of less than 6 wt %.
51. The process according to any one of clauses 36 to 50 wherein the frozen confection product is selected from ice cream, frozen custard, ice milk, frozen yogurt, sherbet, and water ices, mellorine, frozen dairy desserts for special dietary purposes, dairy dessert bars.
52. The process according to any one of clauses 36 to 51 wherein the frozen confection product is selected from ice cream and mellorine.
53. Use of fat composition consisting of a liquid oil and an interesterified lauric fat to reduce the saturated fat content of a frozen confection product.
54. The use according to clause 53 wherein the fat composition is present in the frozen confection product in an amount of 2 to 10 wt % fat composition based on the weight of the frozen confection product.
55. The use according to clause 53 or 54 wherein the saturated fat content is reduced with at least 50%.
56. The use according to any one of clauses 53 to 55 wherein the saturated fat content is reduced with at least 55%.
57. The use according to any one of clauses 53 to 56 wherein the fat composition is consisting of weight ratio of 55 wt % liquid oil and 45 wt % interesterified lauric fat, to a weight ratio of 60 wt % liquid oil and 40 wt % interesterified lauric fat.
58. The use according to any one of clauses 53 to 57 wherein the fat composition is consisting of weight ratio of 57 wt % liquid oil and 43 wt % interesterified lauric fat, to a weight ratio of 58 wt % liquid oil and 42 wt % interesterified lauric fat.
59. The use according to any one of clauses 53 to 58 wherein the lauric fat of the interesterified fat is selected from coconut oil, coconut stearin, babassu oil, palm kernel oil or palm kernel stearin, cohune oil, tacum oil and cuphea oil, hydrogenated coconut oil, palm kernel oil, fully or partially hydrogenated palm kernel oil, palm kernel stearin, hydrogenated palm kernel stearin, palm kernel olein, fully or partially hydrogenated palm kernel olein, or a mixture of two or more thereof.
60. The use according to any one of clauses 53 to 59 wherein the interesterified fat is interesterified coconut oil.
61. The use according to any one of clauses 53 to 60 wherein the liquid oil is selected from the group consisting of: rapeseed oil, high oleic rapeseed oil, sunflower oil, high oleic sunflower oil, canola oil, high oleic canola oil, high oleic soybean oil, soybean oil, flaxseed oil, grapeseed oil, olive oil, peanut oil, corn oil, groundnut oil, cottonseed oil and a combination of two or more thereof.
62. The use according to any one of clauses 53 to 61 wherein the liquid oil is derived from sunflower oil.
63. The use according to any one of clauses 53 to 62 wherein the liquid oil is high oleic sunflower oil.
64. The use according to any one of clauses 53 to 63 wherein the fat composition is consisting of high oleic sunflower oil and interesterified coconut oil.
65. The use according to any one of clauses 53 to 64 wherein the fat composition is consisting of 60 wt. % high oleic sunflower oil and 40 wt % of interesterified coconut oil.
66. The use according to any one of clauses 53 to 65 wherein the fat composition has a fatty acid moiety content of C12 of not more than 20 wt. %.
67. The use according to any one of clauses 53 to 66 wherein the fat composition has a solid fat content at 10° C. of less than 25 wt. % and at 20° C. of less than 6 wt %.
68. The use according to any one of clauses 53 to 67 wherein the frozen confection product is selected from ice cream, frozen custard, ice milk, frozen yogurt, sherbet, and water ices, mellorine, frozen dairy desserts for special dietary purposes, dairy dessert bars.
69. The use according to any one of clauses 53 to 68 wherein the frozen confection product is selected from ice cream and mellorine.
70. A fat composition consisting of a liquid oil and an interesterified lauric fat wherein the interesterified fat is selected from coconut oil, coconut stearin, babassu oil, palm kernel oil or palm kernel stearin, cohune oil, tacum oil and cuphea oil, hydrogenated coconut oil, palm kernel oil, fully or partially hydrogenated palm kernel oil, palm kernel stearin, hydrogenated palm kernel stearin, palm kernel olein, fully or partially hydrogenated palm kernel olein, or a mixture of two or more thereof and, the liquid oil is selected from the group consisting of: rapeseed oil, high oleic rapeseed oil, sunflower oil, high oleic sunflower oil, canola oil, high oleic canola oil, high oleic soybean oil, soybean oil, flaxseed oil, grapeseed oil, olive oil, peanut oil, corn oil, groundnut oil, cottonseed oil and a combination of two or more thereof.
71. A fat composition consisting of weight ratio of 55 wt % high oleic sunflower oil and 45 wt % interesterified coconut oil, to a weight ratio of 60 wt % high oleic sunflower oil and 40 wt % interesterified coconut oil.
72. The fat composition according to any one of clauses 70 to 71 wherein fat composition has a ratio of fatty acid moieties C12/C16 of 2 to 3.8.
73. The fat composition according to any one of clauses 70 to 72 wherein fat composition is containing less than 50 wt. % of saturated fatty acids.
74. The fat composition according to any one of clauses 70 to 73 wherein fat composition has a content of C12+C16 of less than 30 wt. %.

### EXAMPLES

### 1. The Fat Composition

Refined coconut oil (Cargill), randomly interesterified coconut (Cargill) and high oleic sunflower oil (Cargill) were used in the preparation of the fat compositions.

The weight ratio of the components and the fatty acid profile of the fat composition are shown in table 1.

TABLE 1
Composition of the fat compositions & fatty acid profile

| | | |
|---|---|---|
| Nº 1 | Nº 2 | Nº 3 |

Composition of the fat composition

| | | | |
|---|---|---|---|
| Refined coconut | 100 | 50 | |
| oil | | | |
| Interesterified | | | 40 |
| coconut oil | | | |
| High oleic | | 50 | 60 |
| sunflower oil | | | |

Fatty acid profile of the fat composition

| | | | |
|---|---|---|---|
| C12 | 45% | 22% | 18% |
| C16 | 11% | 7% | 7% |
| C18 | 3% | 3% | 3% |
| C16 + C18 | 14% | 10% | 10% |
| C12 + C16 | 56% | 29% | 25% |
| C12/C16 | 4.1 | 3.1 | 2.6 |
| SAFA | 92% | 50% | 42% |

Solid fat content, %

| | | | |
|---|---|---|---|
| N10 | 81.0 | 27.0 | 22.8 |
| N15 | 66.6 | 15.6 | 13.8 |
| N20 | 41.1 | 2.5 | 4.6 |
| N25 | 0.0 | 0.0 | 0.0 |
| N30 | 0.0 | 0.0 | 0.0 |

### 2. Recipe of the Frozen Confection Product

The recipe of the frozen confection products is shown in table 2.

TABLE 2
Recipe of the frozen confection product, ice cream

| | Ice | | |
|---|---|---|---|
| | cream | Ice | Ice |
| | Product | cream | cream |
| | A | product | product |
| Raw material used | (reference) | B | C |
| Tap water | 66.0 | 66.0 | 66.0 |
| Fat composition Nº 1 | 6.0 | | |
| Fat composition Nº 2 | | 6.0 | |
| Fat composition Nº 3 | | | 6.0 |
| Skimmed milk powder | 3.5 | 3.5 | 3.5 |
| Whey protein concentrate | 2.7 | 2.7 | 2.7 |
| Sugar | 9.0 | 9.0 | 9.0 |
| Glucose-fructose syrup | 12.0 | 12.0 | 12.0 |
| Stabilizer | 0.6 | 0.6 | 0.6 |

### 3. Preparation of the Frozen Confection Product, Ice Cream

The fat compositions were placed in the oven (oven used is a Memmert, FED 720) the day before making the ice cream. The fat was heated at a temperature of 65° C. Then, on the day of preparing the ice cream, all powders (of the recipe) were weighed and blended in a plastic bag. The water was heated to a temperature of 70° C. and was added into a bucket of 25 L. The blended powder was added into the water and mixed using a typhoon high shear mixer for 1 minute at 1500 rpm. Furthermore, the glucose-fructose syrup and the stabilizer (if liquid) were added into the liquid mix and mixed for 1 minute at 1500 rpm. Lastly, the molten fat composition was added on top and blended under high shear using a typhoon high shear mixer for 10 minutes at 1500 rpm. The thus obtained homogenous mixture was subjected to a heat treatment, homogenization & cooling using a GEA TDS 00A1847. The heat treatment was done at 86° C. for 30 seconds, followed by a homogenization at 180+30 bars and subsequent cooling at 10° C. The mixture was collected in sterilized 25 L buckets and closed with a lid. The buckets were transferred to a fridge at 5° C. and subjected to an aging for 18 hours. After the 18 hours, the mixture was frozen and aerated using a Tetra Hoyer KF 80 continuous freezer. The mixture was frozen to −6° C. and aerated with a target of 100% overrun. The thus obtained frozen ice cream was filled aseptically in plastic pots of 1000 ml & 250 ml and quickly cooled in a Koma KCF-15 blast freezer at −40° C. for 4 hours to harden and to complete crystallization. After 4 hours, the pots were transferred to final storage in a freezer at −18° C.

### 4. Evaluation of the Frozen Confection Product, Ice Cream

### Measuring the Melting Profile of the Ice Cream Products

3 balances (Mettler Toledo NewClassic MF ML2001) alongside the Mettler Toledo easy service/application controller software were used to simultaneously determine the melting speed of different ice cream products at room temperature (20° C.).

Ice cream product A in a 250 ml pot was transferred in a freezer overnight at a temperature of −20° C. Before the test, O-shaped holders were attached to a metal rod above the balances. On these holders metal grids were installed to allow the molten ice cream product A to run through. Furthermore, plastic containers were put on top of the balances to collect the molten ice cream product A and allow the amount to be weighed and registered by the software. Ice cream product A was then removed from the freezer and the weight of the plastic pot & ice cream is noted down. The plastic pot was then removed by using a knife to remove the bottom of the pot and then along the side of the plastic to demold ice cream product A onto the grid. The empty plastic pot was weighed to know the adjusted weight of ice cream product A (pot+ice cream product A−pot=absolute weight ice cream product A). This procedure was repeated for ice cream product B, and ice cream product C. After all ice cream products are put on their subsequent grids, the procedure is started through the software. Every 10 seconds, the software registered the weight from the balances and the value was stored. The procedure was completed when all ice creams were melted or after 180 minutes.

TABLE 3
Melting profiles

| | Ice cream | Ice cream | Ice cream |
|---|---|---|---|
| | Product A | Product B | Product C |
| Time (min) for Start | 25 | 20 | 19 |
| melting | | | |
| Time (min) for | 45 | 29 | 28 |
| melting 10 g | | | |
| Time (min) for | 61 | 44 | 43 |
| melting 30 g | | | |
| Time (min) for | 84 | 71 | 70 |
| melting 60 g | | | |

The Ice Cream Product C has same melting curve as Ice Cream Product B, where product C has lower SAFA content vs. product B. The combination of interesterified Coconut oil and liquid oil is leading to different physical properties, in this case a higher oil binding capacity vs. the combination of coconut oil and liquid oil.

Sensory Evaluation of Different Fat Ingredient Source within Milk Ice Cream

For the sensory evaluation an external trained panel with 9-12 panelists have been used. The samples were tasted in 4 repetitions. For the serving procedure the samples were randomized with a 3-digit code and as quantity 1 jar of 120 ml frozen ice cream with a temperature of −13° C. served. On the testing protocol: the samples are swallowed and there was a break of 2 minutes between the samples. The order of serving was randomized and there were 2 products in one session evaluated. The methodology has a 95% confidence level for the comparison. The addition of vegetable oil to coconut oil or interesterified coconut oil to the ice cream sample results into a change of texture attributes, like Fullness, Density and Viscosity. The Blends have a less full mouthfeel perception and a more airy, foamy texture/mouthfeel perception. The sensory profile differences between Ice cream product B and Ice cream product C are very small. On evaluation of Texture-Mouthfeel attributes like Fullness, Density and Viscosity/Thickness the results are very similar. The lower saturated fatty acid content of the fat phase in Ice cream product C is getting stabilized by the randomization during Interesterification of the Coconut oil.

### BENEFITS

The addition of vegetable liquid oils to Interesterified Coconut oil allows to produce Milk Ice cream products with a balanced nutritional profile and more favorable taste and mouthfeel attributes compared to milk ice cream products which contain Coconut oil and vegetable liquid oils.

It was found that the same melting curve of the ice cream is obtained with the claimed fat composition that has a lower SAFA content and lower solid fat content at 10° C. and 15° C. compared to coconut oil and/or a blend of coconut oil with liquid oil used in existing frozen confection products.

1. A frozen confection product comprising protein, sweetener, emulsifier, stabilizer and fat and the fat is consisting of a fat composition wherein
the fat composition has a fatty acid moiety content with a carbon chain length of C12 of not more than 20% based on total weight of the fatty acid moiety; and
the fat composition has a solid fat content at 10° C. of less than 25 wt. % and at 20° C. of less than 6 wt %; and
the fat composition is consisting of a liquid oil and an interesterified lauric fat and having a weight ratio of from 55 wt % liquid oil and 45 wt % interesterified lauric fat, to a weight ratio of 60 wt % liquid oil and 40 wt % interesterified lauric fat.

2. The frozen confection product according to claim 1 wherein the frozen confection product is selected from ice cream, frozen custard, ice milk, frozen yogurt, sherbet, and water ices, mellorine, frozen dairy desserts for special dietary purposes, dairy dessert bars.

3. The frozen confection product according to claim 1 wherein the frozen confection product is selected from ice cream and mellorine.

4. The frozen confection product according to claim 1 wherein fat composition of the frozen confection product has a ratio of fatty acid moieties C12/C16 of 2 to 3.8.

5. The frozen confection product according to claim 1 wherein fat composition of the frozen confection product is containing less than 50 wt. % of saturated fatty acids.

6. A process for preparing the frozen confection product according to claim 1 and the process is comprising:
Blending a fat composition with frozen confection product ingredients different from fat,
Freezing the blend, and
wherein the fat composition is consisting of a liquid oil and an interesterified lauric fat; and the fat composition is having a weight ratio of from 55 wt % liquid oil and 45 wt % interesterified lauric fat, to a weight ratio of 60 wt % liquid oil and 40 wt % interesterified lauric fat.

7. Use of fat composition consisting of a liquid oil and an interesterified lauric fat to reduce the saturated fat content of a frozen confection product, and wherein the fat composition is having a weight ratio of from 55 wt % liquid oil and 45 wt % interesterified lauric fat, to a weight ratio of 60 wt % liquid oil and 40 wt % interesterified lauric fat.

8. The use according to claim 7 wherein the fat composition is present in the frozen confection product in an amount of 2 to 10 wt % of the fat composition based on the weight of the frozen confection product.

9. The use according to claim 7 wherein the saturated fat content is reduced with at least 50%.

10. A fat composition consisting of a liquid oil and an interesterified lauric fat wherein the interesterified fat is derived from coconut oil, coconut stearin, babassu oil, palm kernel oil or palm kernel stearin, and the liquid oil is selected from the group consisting of rapeseed oil, high oleic rapeseed oil, sunflower oil, high oleic sunflower oil or a mixture of two or more thereof; and wherein
the fat composition is having a weight ratio of from 55 wt % liquid oil and 45 wt % interesterified lauric fat, to a weight ratio of 60 wt % liquid oil and 40 wt % interesterified lauric fat; and
the fat composition has a solid fat content at 10° C. of less than 25 wt. % and at 20° C. of less than 6 wt %.

11. The fat composition according to claim 10 wherein the liquid oil is derived from sunflower oil and the interesterified fat is interesterified coconut oil.

12. The fat composition according to claim 10 wherein the fat composition has a fatty acid moiety content of C12 of not more than 20 wt. %.

13. The fat composition according to claim 10 wherein fat composition has a ratio of fatty acid moieties C12/C16 of 2 to 3.8.

14. The fat composition according to claim 10 wherein fat composition is containing less than 50 wt. % of saturated fatty acids.

15. The fat composition according to claim 10 wherein fat composition has a content of C12+C16 of less than 30 wt. %.
